(19) United States
(12) Patent Application Publication
(10) Pub. No.: US 2026/0179901 A1
(43) Pub. Date: Jun. 25, 2026

(54) SURFACE DOPING OF LITHIUM AND MANGANESE-RICH POWDER FOR IMPROVED CYCLING STABILITY

(71) Applicant: GM Global Technology Operations LLC, Detroit, MI (US)

(72) Inventors: Vamakshi Yadav, Sterling Heights, MI (US); Zhongyi Liu, Troy, MI (US); Nicholas Paul William Pieczonka, Troy, MI (US); Raneen Taha, Sterling Heights, MI (US)

(73) Assignee: GM Global Technology Operations LLC, Detroit, MI (US)

(21) Appl. No.: 19/000,918

(22) Filed: Dec. 24, 2024

(51) Int. Cl. H01M 4/04; H01M 4/02; H01M 4/1391

(52) U.S. Cl. CPC H01M 4/0416; H01M 4/0471; H01M 4/1391; H01M 2004/028; H01M 2220/20

(57) ABSTRACT

A method of doping a battery cathode includes preparing a coating with a complex including a metal-based molecular precursor, applying the coating to a battery cathode, and calcining the coating applied to the battery cathode at a calcination temperature of at least 300° C.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery cathodes. More specifically, the present disclosure relates to applying a metal oxide to a cathode of a lithium-ion battery.

Vehicles are often equipped with batteries for various purposes. Batteries have varying cycle lives and discharge capacities, which can be increased or decreased depending on various films that may be applied at a cathode of the battery. For example, applying a metal oxide-based film may improve the cycle life of the cathode material and, therefore, the battery. One technique for coating the cathode includes vapor deposition, such as atomic layer deposition (ALD) and chemical vapor deposition (CVD). However, applying a film layer to the cathode may result in a decrease in the overall discharge capacity of the battery. Thus, there is a need for an improved process for coating cathodes of batteries while maintaining or improving both the cycle life and the discharge capacity of the battery.

### SUMMARY

In some aspects, a method of doping a battery cathode includes preparing a coating with a complex including a metal-based molecular precursor, applying the coating to a battery cathode, and calcining the coating applied to the battery cathode at a calcination temperature of at least 300° C.

In some examples, the metal-based molecular precursor may include organic ligands. In some configurations, the metal-based molecular precursor may be a metal alkoxide. In some instances, the metal alkoxide may include a metal isopropoxide. Optionally, the metal isopropoxide may include one or more of aluminum isopropoxide, titanium isopropoxide, manganese isopropoxide, boron isopropoxide, sodium isopropoxide, lithium isopropoxide, and potassium isopropoxide. Additionally or alternatively, the complex may include at least two metal-based molecular precursors, each metal-based molecular precursor including a different metal alkoxide. In further examples, the metal alkoxide coating may include 0.01 percent weight (wt. %) to two (2) percent weight (wt. %) of a transition metal.

In other examples, the battery cathode may include includes at least one of a lithium and manganese-rich (LMR) cathode, a nickel manganese cobalt oxide (NMC) cathode, a nickel cobalt manganese aluminum (NCMA) cathode, a lithium iron phosphate (LFP) cathode, a lithium nickel dioxide (LNO) cathode, a lithium manganese iron phosphate (LMFP) cathode, a lithium manganese oxide (LMO) cathode, and a lithium nickel manganese oxide (LNMO) cathode.

In other aspects, a method of doping a battery includes preparing a coating with a complex including a metal alkoxide having organic ligands, applying the coating to a battery cathode, and calcining the coating applied to the battery cathode at a calcination temperature of at least 300° C. In some examples, the metal alkoxide may include a metal isopropoxide. Optionally, the metal isopropoxide may include one or more of aluminum isopropoxide, titanium isopropoxide, manganese isopropoxide, boron isopropoxide, sodium isopropoxide, lithium isopropoxide, and potassium isopropoxide. Additionally or alternatively, the complex may include at least two metal alkoxides. In other examples, the metal alkoxide coating may include 0.01 percent weight (wt. %) to two (2) percent weight (wt. %) of a transition metal. In further examples, the calcination temperature may be a temperature from 400° C. to 900° C.

In some examples, the battery cathode may include at least one of a lithium and manganese-rich (LMR) cathode, a nickel manganese cobalt oxide (NMC) cathode, a nickel cobalt manganese aluminum (NCMA) cathode, a lithium iron phosphate (LFP) cathode, a lithium nickel dioxide (LNO) cathode, a lithium manganese iron phosphate (LMFP) cathode, a lithium manganese oxide (LMO) cathode, and a lithium nickel manganese oxide (LNMO) cathode.

In other aspects, a method of doping an LMR cathode of a battery for use in a vehicle includes preparing a coating including an alcohol-based solution that includes a metal-based molecular precursor. The metal-based molecular precursor includes aluminum isopropoxide, and the aluminum isopropoxide has organic ligands. The method also includes spraying the coating on an LMR cathode of a battery and drying the coating. The method further includes evaporating alcohol of the coating to define a coating layer of aluminum isopropoxide on the LMR cathode. The coating layer of aluminum isopropoxide includes 0.58 percent weight (wt. %) of aluminum ions. The method also includes calcining the coating layer at the LMR cathode at a calcination temperature of at least 450° C. to define a doped LMR cathode, the doped LMR cathode being doped with the aluminum ions. The method further includes installing the battery at a vehicle and coupling at least one electrical component of the vehicle to the battery.

In some examples, the calcination temperature may be a temperature ranging from 450° C. to 900° C. In other examples, spraying the coating may include spraying the alcohol-based solution from a nozzle at a frequency of 0.2 Hertz (Hz) and a flow rate of five (5) cubic centimeters per minute (cc/min). In still other examples, drying the coating may include circulating air across the LMR cathode at a rate of thirty (30) liters of air per minute (L/min), and the temperature of the air may be eighty (80) degrees Celsius (° C.). Optionally, the alcohol of the alcohol-based solution may include one or more of ethanol, methanol, and isopropanol. The alcohol-based solution may have a concentration of one (1) gram (g) of aluminum isopropoxide per thirty (30) milliliters (mL) of alcohol. In further examples, the metal-based molecular precursor may include one or more of titanium isopropoxide, manganese isopropoxide, boron isopropoxide, sodium isopropoxide, lithium isopropoxide, and potassium isopropoxide

### BRIEF DESCRIPTION OF THE DRAWINGS

The drawings described herein are for illustrative purposes only of selected configurations and are not intended to limit the scope of the present disclosure.

FIG. 1 is a perspective view of a vehicle that includes a battery according to the present disclosure;

FIG. 2 is a perspective view of a battery according to the present disclosure;

FIG. 3 is an exemplary block diagram for a battery according to the present disclosure and reference batteries;

FIG. 4 is an exemplary flowchart of a method of doping a battery cathode according to the present disclosure; and

FIG. 5 is an example graph of battery performance characteristics of a battery according to the present disclosure in comparison with reference batteries.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

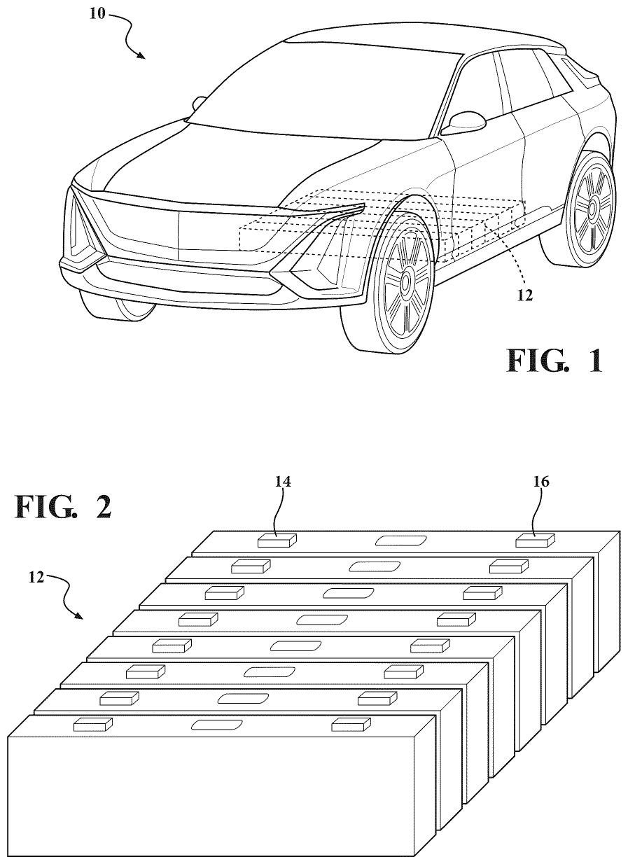

Referring to FIGS. 1-3, a vehicle 10 includes a battery 12, such as a lithium-ion battery, configured to at least partially power the vehicle 10. For example, the vehicle 10 may be an electric vehicle (EV) or a hybrid vehicle equipped with the battery 12 and an internal combustion engine (ICE). The battery 12 includes at least two electrodes including a cathode 14 and an anode 16, at which EV components powered by the battery 12 may be coupled. The cathode 14 is composed of cathode active materials 18 configured to optimize various aspects of a battery performance 20 (e.g., electrochemical performance) of the battery 12. For example, the battery performance 20 may include at least one of an energy density, power density, and thermal stability of the battery 12. In some nonlimiting examples, the cathode active materials 18 may include lithium and manganese-rich (LMR), nickel manganese cobalt oxide (NMC), a nickel cobalt manganese aluminum (NCMA), lithium iron phosphate (LFP), lithium nickel dioxide (LNO), lithium manganese iron phosphate (LMFP), lithium manganese oxide (LMO), and lithium nickel manganese oxide (LNMO).

Another metric of the battery performance 20 is a discharge capacity 24 of the battery 12. The discharge capacity 24 refers to the amount of charge the battery 12 can retain per unit of mass. A higher discharge capacity 24 translates to a greater amount of charge that the battery 12 can retain. The cycle stability 26 and a cycle life 30 of the battery 12 may be collectively referred to as a discharge capacity retention 32.

The discharge capacity retention 32 refers to the discharge capacity 24 of the battery 12 tracked across multiple battery cycles 34. For example, if at a first battery cycle 34a, the battery 12 has a discharge capacity 24 of 100 milliampere hours per gram (mAh g⁻¹), and at a second battery cycle 34b, the battery 12 has a discharge capacity 24 of ninety (90) mAh g⁻¹, then the battery 12 has a discharge capacity retention 32 of ninety percent (90%) at the second battery cycle 34b. The battery cycle 34 refers to a complete charging and a complete discharging of the battery 12. For example, one full charge and one full discharge of the battery 12 refers to one battery cycle 34.

The battery 12 also includes a battery life 36, which refers to the number of battery cycles 34 that the battery 12 can complete before the discharge capacity 24 degrades to a threshold capacity 38. An example threshold capacity 38 may be approximately eighty percent (80%) of an initial discharge capacity 24a of the battery 12 (i.e., approximately eighty percent (80%) discharge capacity retention), where the initial discharge capacity 24a is the discharge capacity 24 of the battery 12 at the first battery cycle 34a (i.e., zero (0)). Alternatively, the example threshold capacities 38 may be approximately seventy percent (70%), approximately sixty percent (60%), or approximately fifty percent (50%) of the initial specific discharge capacity 24a of the battery 12.

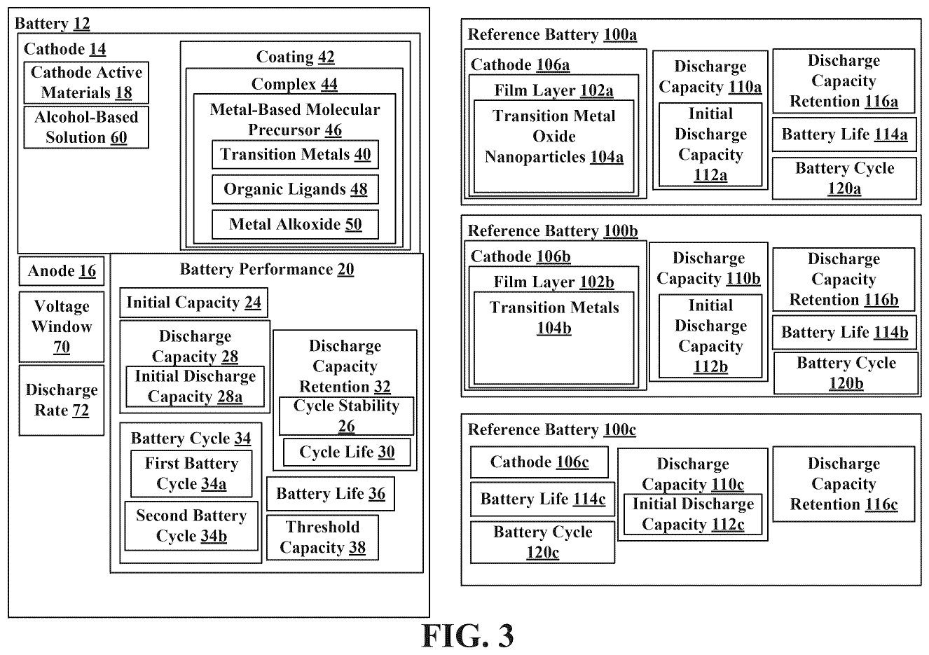

With further reference to FIGS. 1-3, the initial discharge capacity 24a and the battery life 36 of the battery 12 are determined at least in part based on the cathode active materials 18 of the battery 12. Introducing transition metals 40 to the cathode 14 increases the battery life 36. When the transition metals 40 penetrate, or are absorbed into, the cathode 14 (i.e., the cathode 14 is doped with the transition metals 40), the battery 12 will have an increased battery life 36 while maintaining a high initial discharge capacity 24a. In comparison to the battery 12 described herein, a series of reference batteries 100a-100c are depicted in FIG. 3. Due to the substantial similarity, similar numbering may be utilized for each of the reference batteries 100a-100c with letter extensions distinguishing each reference battery 100a-100c. Reference battery 100a may have a film layer 102a of transition metal oxide nanoparticles 104a applied to a cathode 106a. Reference battery 100b may have a film layer 102b including transition metals 104b applied to a cathode 106b via a vapor deposition process. The cathode 106c of reference battery 100c may remain free from a film layer (i.e., cathode 106c is an “uncoated cathode”). Each of the reference batteries 100a-100c have a discharge capacity 110a-110c including an initial discharge capacity 112a-112c and a battery life 114a-114c including a discharge capacity retention 116a-116c. The film layer 102a, 102b on the surface of the cathode 106a, 106b may increase the battery life 114a, 114b but decreases the initial discharge capacity 112a, 112b.

The film layer 102a applied to the cathode 106a may include transition metal oxide nanoparticles 104a. The transition metal oxide nanoparticles 104a may result in non-uniformity of the film layer 102a. The non-uniform film layer 102a will not substantially increase electrical resistance between the cathode 106a and electrical components coupled with the cathode 106a, as observed with cathode 106b. Accordingly, reference battery 100a has a higher initial discharge capacity 112a than the initial discharge capacity 112b of reference battery 100b. However, the non-uniform film layer 102a will not create a barrier between the cathode 106a and electrolyte of the reference battery 100a. Accordingly, film layer 102a only modestly improves the discharge capacity retention 116a and the battery life 114a of reference battery 100a when compared to the discharge capacity retention 116c and the battery life 114c of the reference battery 100c with the uncoated cathode 106c

The film layer 102b may be applied to the cathode 106b via a vapor deposition process, such as atomic layer deposition (ALD) and chemical vapor deposition (CVD). The vapor deposition process provides a consistent layer (i.e., film) of the film layer 102b along the cathode 106b. The film layer 102b results in an increase in electrical resistance between the cathode 106b and electrical components that may be coupled to the reference battery 100b. Accordingly, the reference battery 100b has a lower initial discharge capacity 110b than the discharge capacity 110c of the reference battery 100c having an uncoated cathode 106c (i.e., a cathode 106c with no film layer 102a, 102b). However, the film layer 102b of transition metals 104b creates a barrier between the cathode 106b and electrolyte of the reference battery 100b, giving the reference battery 100b a higher discharge capacity retention 116b and longer battery life 114b when compared to the discharge capacity retention 116c and the battery life 114c of the reference battery 100c with the uncoated cathode 106c.

In contrast, the cathode 14 of the battery 12 is doped with the transition metals 40, which increase the discharge capacity retention 32 of the battery 12 while maintaining the initial discharge capacity 24a. For example, the maintained initial discharge capacity 24a of the doped cathode 14 is approximately equivalent to the initial discharge capacity 112c of the reference battery 100c with the uncoated cathode 106c. The process of doping the cathode 14 with the transition metals 40 involves applying a coating 42 to the cathode 14 that includes a complex 44 including a metal-based molecular precursor 46. In an example aspect, the metal-based molecular precursor 46 is a metal alkoxide 50 that includes the transition metals 40 and organic ligands 48. The process of doping the cathode 14 further includes calcining the coating 42 to define a doped cathode 14. As the complex 44 decomposes during calcination, the organic ligands 48 break off from the transition metals 40 of the metal-based molecular precursor 46, and the transition metals 40 are uniformly absorbed and distributed in the cathode 14. For example, ions of the transition metals 40 migrate into the cathode 14.

As a result, resistance between the cathode 14 and electrical components coupled to the battery 12 is minimized. The doping of the cathode 14 results in the ions of the transition metals 40 being absorbed into the cathode 14, as opposed to leaving a film layer on a surface of the cathode 14. The cathode 14 doped with the transition metals 40 creates a barrier between the cathode 14 and electrolyte of the battery 12. Accordingly, the battery 12 having the cathode 14 doped with the transition metals 40 increases battery life 36 and discharge capacity retention 32 without reducing the initial discharge capacity 24a of the battery 12. Thus, the battery 12 has approximately the same increased battery life 36 and discharge capacity retention 32 as reference battery 100b, while maintaining approximately the same initial discharge capacity 24a as reference battery 100c.

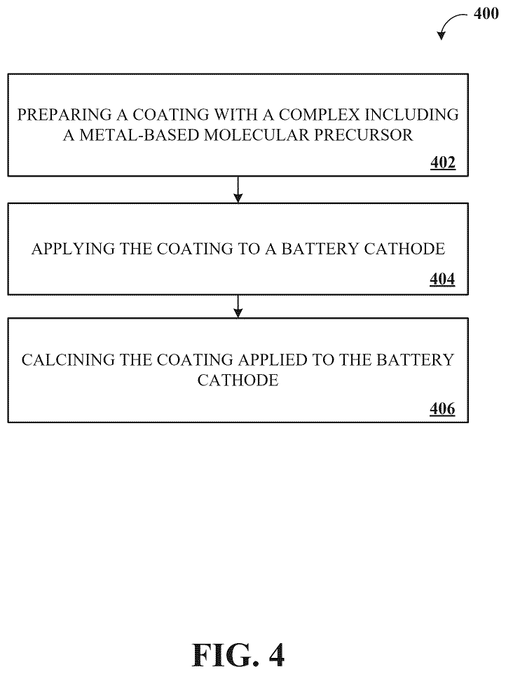

As illustrated in FIG. 4, a method 400 of doping a cathode 14 includes preparing, at 402, a coating 42 with a complex 44 including a metal-based molecular precursor 46, applying, at 404, the coating 42 to the cathode 14, and calcining, at 406, the coating 42 applied to the cathode 14. The coating 42 prepared for doping the cathode 14 is prepared with a selected complex 44. The complex 44 may include one or more metal-based molecular precursors 46. In one aspect, each metal-based molecular precursor 46 may include a metal alkoxide 50. By way of example, not limitation, the complex 44 may include at least two metal-based molecular precursors 46, each metal-based molecular precursor 46 including a metal alkoxide 50 including a different transition metal 40. Exemplary metal alkoxides 50 may include a metal isopropoxide, including, but not limited to, aluminum isopropoxide, titanium isopropoxide, manganese isopropoxide, boron isopropoxide, sodium isopropoxide, lithium isopropoxide, or potassium isopropoxide.

Applying the coating 42 of the complex 44 to the battery cathode 12 includes spray drying the cathode 14 with the complex 44. The coating 42 is a thin, uniform layer of the complex 44 applied to the surface of the cathode 14. Spray drying the cathode 14 includes preparing a concentration of the complex 44 in an alcohol-based solution 60. In some examples, the complex 44 may be in the form of a powder when introduced to the alcohol-based solution 60. Example alcohols of the alcohol-based solution 60 include ethanol, methanol, and isopropanol. The alcohol-based solution 60 may have a concentration of 0.5 grams (g) of metal alkoxide per thirty (30) milliliters (mL) of alcohol to two (2) grams (g) of metal alkoxide per thirty (30) milliliters (mL) of alcohol. An example concentration of the alcohol-based solution 60 is approximately one gram (1 g) of metal alkoxide per thirty (30) milliliters (mL) of alcohol. Exemplary spray drying includes applying the complex 44 to the cathode 14 using a nozzle. In one aspect, the nozzle may have a flow rate of two (2) cubic centimeters per minute (cc/min) to twenty (20) cubic centimeters per minute (cc/min). An exemplary nozzle flow rate is approximately five (5) cubic centimeters per minute (cc/min). In another aspect, the nozzle may have a cleaner frequency of 0.1 Hertz (Hz) to one (1) Hertz (Hz). An example nozzle cleaner frequency is 0.2 Hertz (Hz).

The example spray drying further includes drying the cathode coated with the alcohol-based solution, where drying includes circulating a drying gas across the cathode. In one aspect, the drying gas is circulated at a gas flow rate of fifteen (15) liters per minute (L/min) to fifty (50) liters per minute (L/min). In another aspect, the drying gas is circulated at a gas temperature of seventy (70) degrees Celsius (° C.) to ninety (90) degrees Celsius (° C.). In yet another aspect, the drying gas may be air, nitrogen, or argon. Exemplary drying includes circulating air across the cathode at a gas flow rate of thirty (30) liters of air per minute (L/min) and a gas temperature of approximately eighty (80) degrees Celsius. The spray drying results in the thin, uniform coating 42 of the complex 44 on the surface of the cathode 14. The coating 42 may have a concentration of 0.01 percent weight (wt. %) to two (2) percent weight (wt. %) of transition metals 40. In one example, the coating 42 has a concentration of 0.58 wt. % of transition metals 40.

With further reference to FIGS. 2-5, the film layers 102a of the reference batteries 100a may utilize transition metal oxide nanoparticles 104a that do not readily decompose, resulting in a non-uniform film layer 102a of transition metal oxide nanoparticles 104a along the cathode 106a. Comparatively, the complex 44 of the coating 42 includes organic ligands 48. Unlike transition metal oxide nanoparticles 104a, organic ligands 48 readily decompose from the transition metals 40 during calcination. The remaining transition metals 40 absorb into cathode 14 once the organic ligands 48 have decomposed. The organic ligands 48 thus result in the metal-based molecular precursor 46 doping the cathode during calcination.

Calcination includes applying heat or otherwise increasing a temperature of the cathode 14 to induce the organic ligands 48 to decompose relative to the metal-based molecular precursors 46 (i.e., the metal alkoxide 50). For example, during calcination, the organic ligands 48 break away from the metal-based molecular precursors 46. As a result, the metal alkoxides 50 of the coating 42 are absorbed (i.e., doped) into the cathode 14. The cathode 14 may thus be free of a separate film as a result of the doping process, as the metal-based molecular precursors 46 are integrated into the cathode 14. The decomposition of the organic ligands during calcination of the complex 44 leaves the metal alkoxides 50 free to be absorbed by the cathode 14.

Calcining the complex coated cathode 14 includes heating the coated cathode 14 at a temperature of at least approximately 300° C. In one example, the coated cathode 14 may be heated at a temperature of approximately 450° C. Heating the coated cathode 14 decomposes the organic ligands 48 of the complex 44, such that the transition metals 40 (e.g., metal alkoxide 50) remain integrally bonded with the cathode 14. Decomposition of the organic ligands 48 may begin at approximately 200° C., and doping of the cathode 14 with transition metals 40 may begin at approximately 300° C. Doping may continue from approximately 300° C. to approximately 900° C. During doping, the transition metals 40 penetrate the cathode active materials 18. Accordingly, as a result of the doping process, the cathode 14 is free from a film or exterior coating with the transition metals 40 at a surface of the cathode 14. Instead, the transition metals 40 are uniformly absorbed and distributed in the cathode 14 as the metal alkoxide 50 migrates into the cathode 14. For example, the metal alkoxide 50 used with the coating 42 may be an aluminum isopropoxide and the cathode 14 may have an LMR lattice. As a result of the calcination process, aluminum ions may migrate into the LMR lattice of the cathode 14 resulting in an aluminum-LMR composite cathode 14.

The cathode 14, coated with transition metals 40, prior to doping, may have a microscopically visible layer of the transition metals 40 on the surface of the cathode 14 as the transition metals 40 are disposed on the surface, but not yet absorbed into the chemical structure of the cathode 14. In contrast, the transition metals 40 are absorbed into the chemical structure of the cathode 14 after doping and may not be visible on the surface of the cathode 14. For example, microscopic analysis of the cathode 14 may demonstrate that the cathode 14 is generally free of a film or other traces of the transition metals 40 on or along the surface of the cathode 14. Instead, the presence of the transition metals 40 in the LMR lattice may be determined by a reduction in binding energy of the transition-metal-doped cathode 14.

Doping a battery cathode with transition metals 40 may improve battery performance 20 for cathodes 14 of varying cathode active materials 18, including LMR cathodes, NMC cathodes, NCMA cathodes, LFP cathodes, LNO cathodes, LMFP cathodes, LMO cathodes, and LNMO cathodes. Doping also may improve battery performance 20 for batteries 12 operating under various operating conditions. A voltage window 70 of the battery 12 may be 2.0 volts (V) to 5.0V. The improved battery performance 20 may also be realized across various discharge rates 72 (i.e., c-rates). Example discharge rates 72 may vary from a 100-hour discharge to a 10-minute discharge.

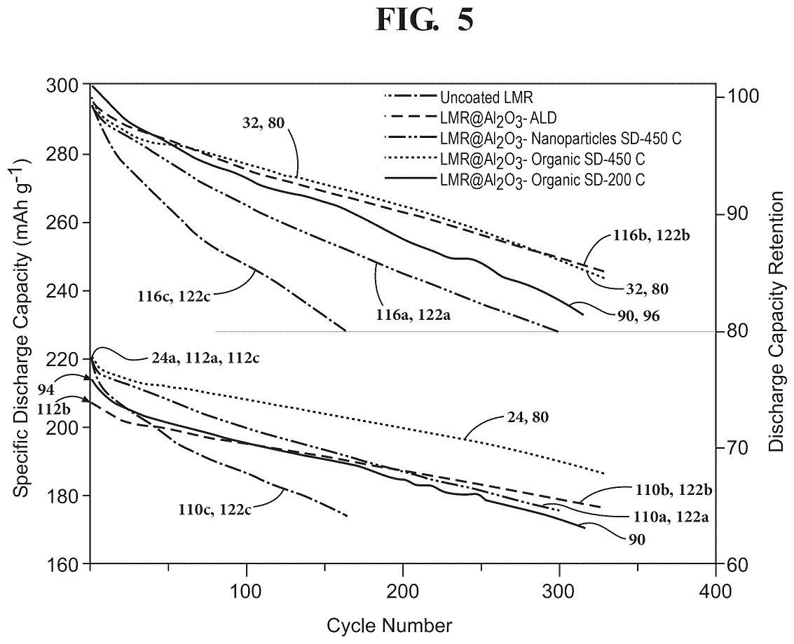

FIG. 5 illustrates an exemplary graph representing a discharge capacity 24 of the battery 12 and discharge capacities 110a-110c of reference batteries 100a-100c plotted over a number of battery cycles 34, 120a-120c, as well as discharge capacity retention 32, 116a-116c of the battery 12 and reference batteries 100a-100c. Plotline 122c illustrates a battery performance of the reference battery 100c with an uncoated LMR cathode 106c. Plotline 122b illustrates a battery performance of the reference battery 100b of the same design and with the same LMR cathode, but the LMR cathode 106b has been coated with an aluminum-oxide film layer 102b applied using an ALD coating process. As a result of the aluminum-oxide film layer 102b, the reference battery 100b has a lower initial discharge capacity 112b than the initial discharge capacity 112c of the reference battery 100c. The reference battery 100b demonstrates a more gradual decrease in discharge capacity 110b over a number of battery cycles 120b compared to the reference battery 100c, corresponding to the higher discharge capacity retention 116b of reference battery 100b than the discharge capacity retention 116c of reference battery 100c. The increase in discharge capacity retention 116b of battery 100b results from the film layer 102b of transition metals 104b on the surface of the cathode 106b, which produces a barrier between the cathode 106b and electrolyte of the reference battery 100b.

With further reference to FIG. 5, plotline 80 illustrates the discharge performance of the battery 12. The battery 12 has an LMR cathode 14 that has been doped with a complex 44 including an aluminum isopropoxide precursor (i.e., metal-based molecular precursor 46) with organic ligands 48. Through the doping of the LMR cathode 14, aluminum ions integrate or otherwise bond with the LMR cathode 14, while the organic ligands 48 dissipate or otherwise remain unbonded to the LMR cathode 14. The integrated aluminum ions create a barrier between the LMR cathode 14 and electrolyte of the battery 12 without forming a film along the surface of the LMR cathode 14. Thus, the doping of the LMR cathode 14 does not measurably increase the electrical resistance of the surface of the LMR cathode 14.

Accordingly, the battery 12 has an initial discharge capacity 24a that is approximately the same as the initial discharge capacity 112c as reference battery 100c, and the battery 12 has a higher discharge capacity retention 32 than the discharge capacity retention 116c of battery 100c. With the improved discharge capacity retention 32 of battery 12, the battery 12 may complete at least approximately 100 more cycles than an uncoated cathode (i.e., the cathode 106c of reference battery 100c) before reaching an end of battery life 36 when cycling at high voltage. The battery 12 also has a higher initial discharge capacity 24a than the initial discharge capacity 112b of reference battery 100b as a result of the doping process, while the battery 12 has a discharge capacity retention 32 that is approximately the same as the discharge capacity retention 116b of reference battery 100b. In sum, the doping process results in the battery 12 having a higher discharge capacity retention 32 as compared with the discharge capacity retention 116c of reference battery 100c and a higher initial discharge capacity 24a than the initial discharge capacity 112b of reference battery 100b.

Plotline 80 and a plotline 122a illustrate the difference in battery performance between the battery 12 and reference battery 100a, respectively. Plotline 122a illustrates the discharge performance of battery 100a, the battery 100a having an LMR cathode 106a that includes a film layer 102a of transition metal oxide nanoparticles 104a. The transition metal oxide nanoparticles 104a do not readily decompose, which results in a non-uniform film layer 102a of transition metal oxide nanoparticles 104a on the surface of the cathode 106a. The non-uniform film layer 102a results in reference battery 100a having reduced discharge capacity retention 116a compared with battery 12.

Plotline 90 illustrates the battery performance of the battery 12 with the cathode 14 prepared with the complex 44 including the metal-based molecular precursor 46 and the organic ligands 48. However, plotline 90 illustrates the cathode 14 of the battery 12 being calcined at a temperature of approximately 200° C., in comparison to plotline 80 where the cathode 14 of the battery 12 has been calcined at a temperature of approximately 450° C. Because 200° C. is approximately the temperature at which decomposition of the organic ligands 48 begins, less of the transition metals 40 have been absorbed into the cathode 14 of the battery 12 compared with when the cathode 14 of battery 12 is calcined at 450° C. As a result of the lower calcination temperature (i.e., approximately 200° C.), some of the transition metals 40 may remain on the surface of the cathode 12 of the battery 14, which may result in the battery 12 having a lower initial discharge capacity 94 than a cathode 14 that has been calcined at a higher temperature of approximately 300° C. to 900° C., such as the cathode 14 of the battery 12 that has been calcined at approximately 450° C. The resultant effect of the battery 12 represented by plotline 90 is that the battery 12 may have a lower discharge capacity retention 96 than the doped cathode 14 of the battery 12 represented by plotline 80.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method of doping a battery cathode, the method comprising:
preparing a coating with a complex including a metal-based molecular precursor;
applying the coating to a battery cathode; and
calcining the coating applied to the battery cathode at a calcination temperature of at least 300° C.

2. The method of claim 1, wherein the metal-based molecular precursor includes organic ligands.

3. The method of claim 1, wherein the metal-based molecular precursor is a metal alkoxide.

4. The method of claim 3, wherein the metal alkoxide includes a metal isopropoxide, the metal isopropoxide including one or more of aluminum isopropoxide, titanium isopropoxide, manganese isopropoxide, boron isopropoxide, sodium isopropoxide, lithium isopropoxide, and potassium isopropoxide.

5. The method of claim 1, wherein the complex includes at least two metal-based molecular precursors, each metal-based molecular precursor including a different metal alkoxide.

6. The method of claim 1, wherein the metal alkoxide coating includes 0.01 percent weight (wt. %) to 2 wt. % of a transition metal.

7. The method of claim 1, wherein the battery cathode includes at least one of a lithium and manganese-rich (LMR) cathode, a nickel manganese cobalt oxide (NMC) cathode, a nickel cobalt manganese aluminum (NCMA) cathode, a lithium iron phosphate (LFP) cathode, a lithium nickel dioxide (LNO) cathode, a lithium manganese iron phosphate (LMFP) cathode, a lithium manganese oxide (LMO) cathode, and a lithium nickel manganese oxide (LNMO) cathode.

8. A method of doping a battery cathode, the method comprising:
preparing a coating with a complex including a metal alkoxide having organic ligands;
applying the coating to a battery cathode; and
calcining the coating applied to the battery cathode at a calcination temperature of at least 300° C.

9. The method of claim 8, wherein the metal alkoxide includes a metal isopropoxide, the metal isopropoxide including one or more of aluminum isopropoxide, titanium isopropoxide, manganese isopropoxide, boron isopropoxide, sodium isopropoxide, lithium isopropoxide, and potassium isopropoxide.

10. The method of claim 8, wherein the complex includes at least two metal alkoxides.

11. The method of claim 8, wherein the metal alkoxide coating includes 0.01 wt. % to 2 wt. % of a transition metal.

12. The method of claim 8, wherein the calcination temperature is a temperature from 400° C. to 900° C.

13. The method of claim 8, wherein the battery cathode includes at least one of a lithium and manganese-rich (LMR) cathode, a nickel manganese cobalt oxide (NMC) cathode, a nickel cobalt manganese aluminum (NCMA) cathode, a lithium iron phosphate (LFP) cathode, a lithium nickel dioxide (LNO) cathode, a lithium manganese iron phosphate (LMFP) cathode, a lithium manganese oxide (LMO) cathode, and a lithium nickel manganese oxide (LNMO) cathode.

14. A method of doping an LMR cathode of a battery for use in a vehicle, the method comprising:
preparing a coating including an alcohol-based solution that includes a metal-based molecular precursor, the metal-based molecular precursor including aluminum isopropoxide, and the aluminum isopropoxide having organic ligands;
spraying the coating on an LMR cathode of a battery;
drying the coating;
evaporating alcohol of the coating to define a coating layer of aluminum isopropoxide on the LMR cathode, the coating layer of aluminum isopropoxide including 0.58 wt. % of aluminum ions;
calcining the coating layer at the LMR cathode at a calcination temperature of at least 450° C. to define a doped LMR cathode, the doped LMR cathode being doped with the aluminum ions;
installing the battery at a vehicle; and
coupling at least one electrical component of the vehicle to the battery.

15. The method of claim 14, wherein the calcination temperature is a temperature ranging from 450° C. to 900° C.

16. The method of claim 15, wherein spraying the coating further includes spraying the alcohol-based solution from a nozzle at a frequency of 0.2 hertz (Hz) and a flow rate of 5 cubic centimeters per minute (cc/min).

17. The method of claim 15, wherein drying the coating further includes circulating air across the LMR cathode at a rate of 30 liters of air per minute, and wherein the temperature of the air is 80° C.

18. The method of claim 15, wherein the alcohol of the alcohol-based solution includes one or more of ethanol, methanol, and isopropanol.

19. The method of claim 15, wherein the alcohol-based solution has a concentration of 1 gram (g) of aluminum isopropoxide per 30 milliliters (mL) of alcohol.

20. The method of claim 15, wherein the metal-based molecular precursor further includes one or more of titanium isopropoxide, manganese isopropoxide, boron isopropoxide, sodium isopropoxide, lithium isopropoxide, and potassium isopropoxide.
